(19) United States
(12) Patent Application Publication
(10) Pub. No.: US 2004/0130903 A1
(43) Pub. Date: Jul. 8, 2004

(54) Auxiliary illuminator for vehicles

(76) Inventor: Kuan-Hsu Chen, Taipei (TW)

Correspondence Address: BIRCH STEWART KOLASCH & BIRCH, PO BOX 747, FALLS CHURCH, VA, 22040-0747, US

(21) Appl. No.: 10/358,194

(22) Filed: Feb. 5, 2003

(30) Foreign Application Priority Data
Jan. 3, 2003 (TW) 9200093

(51) Int. Cl. B60Q 1/00

(52) U.S. Cl. 362/487

(57) ABSTRACT

An auxiliary illuminator for vehicles is composed of a light guiding loop with a plurality f grooves. A light-emitting diode is arranged in each of said groove. The light guiding loop is disposed on rear view mirrors, frame for license plates, headlights, turn signals, tail lights, fog lights, brand names, a dripping baffle, stick shift, or handle of parking brakes for lighting and safety warning. Or the light guiding loop is designed into a linear light guiding bar so as to be disposed on doorsills of cars as safety lighting device or decorative edgings.

### BACKGROUND OF THE INVENTION

1. Field of the Invention

The present invention relates to an auxiliary illuminator for vehicles, especially to an auxiliary illuminator disposed on rear view mirrors, frames for license plates, headlights, turn signals, tail lights, fog lights, brands, a dripping baffle, a stick shift, a handle of parking brake, doorsill, or edgings of vehicles for lighting above vehicle components and as safety warnings.

2. Description of the Prior Art

At evening, there is still some light in surroundings. Most drivers don't turn on the headlights or lights at four corners. In the urban straight roads, there is no trouble. But in mountain area where, the roads are narrow and winding, it is harder for drivers to see other vehicles due to insufficient light thus the probability of car accidents is raised.

Moreover, turn signals are generally fixed on four corners. But on lateral sides of cars, there is no other signal for warning.

Furthermore, steel shield with anti-sliding markings is arranged at a doorsill of traditional cars. Brand name or model name is incused on the steel shield. However, the steel shield is only for anti-sliding without other functions.

At nighttime, there is a small light disposed inside cars. The brightness of the small light is not sufficient to illuminate the doorsills so that people are easy to get tripped while stepping out the cars.

### SUMMARY OF THE INVENTION

It is therefore a primary object of the present invention to provide an auxiliary illuminator for vehicles disposed on rear view mirrors, frames for license plates, headlights, turn signals, tail lights, fog lights, brand names, a dripping baffle, a stick shift, or a handle of parking brake for safety warning or decorations.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an explosive view of the present invention;

FIG. 2 is a cross sectional view of the present invention;

FIG. 3 is an embodiment of the present invention being disposed on different positions of cars;

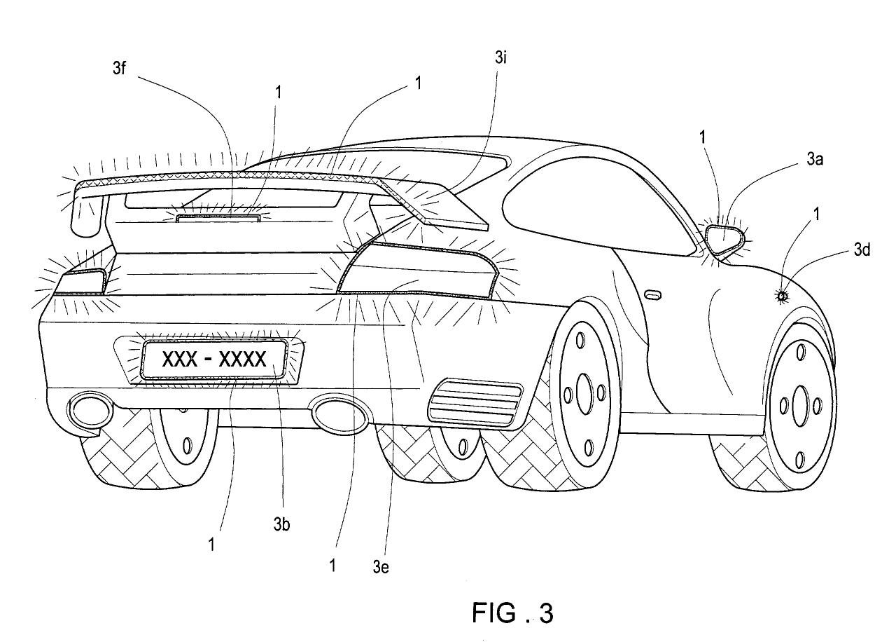

FIG. 4 is an embodiment of the present invention being disposed on other positions of vehicles;

FIG. 5 is an embodiment of the present invention being disposed on a stick shift and a handle of parking brake;

FIG. 6 is a cross sectional view of a linear embodiment of the present invention;

FIG. 7 is an embodiment of the present invention being disposed on a doorsill of cars.

### DETAILED DESCRIPTION OF THE PREFERRED EMBODIMENT

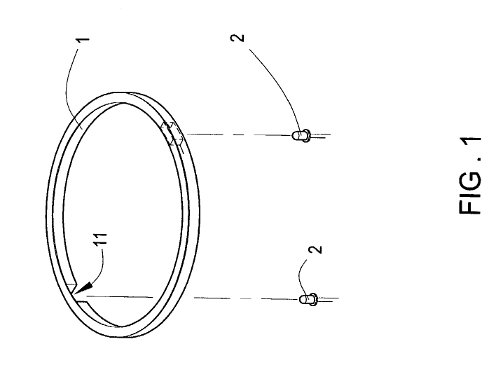

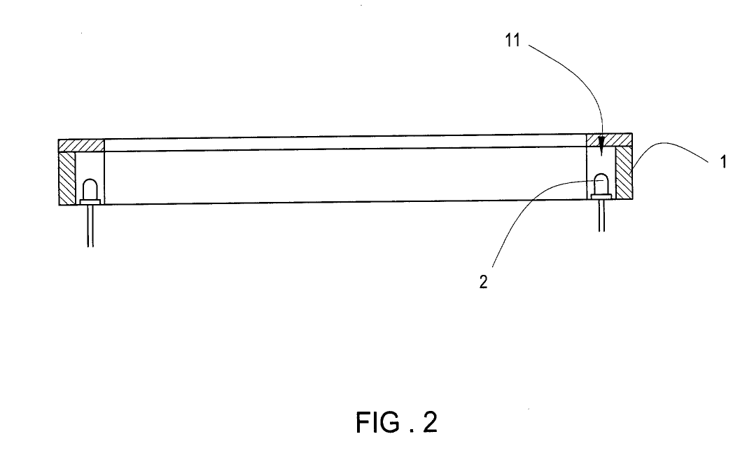

Refer to FIG. 1 & FIG. 2, the present invention is composed by a light guiding loop 1 and a plurality of light-emitting diode 2.

The light guiding loop 1 having a plurality of grooves 11 mounted thereof; and a plurality of light-emitting diode 2 disposed inside the groove 11 of the light guiding loop 1 so that the light guiding loop 1 emits homogeneous light inward.

In accordance with the structure mentioned above, the light guiding loop 1 can be designed into square, rectangular or circular shape. The light guiding loop 1 is disposed on rear view mirrors 3a, frames for license plates 3b, headlights 3c, turn signals 3d, tail lights 3e, the third hazard light 3f, fog lights 3g, brands 3h, a dripping baffle 3i, a stick shift 3j, a handle of parking brake 3k.

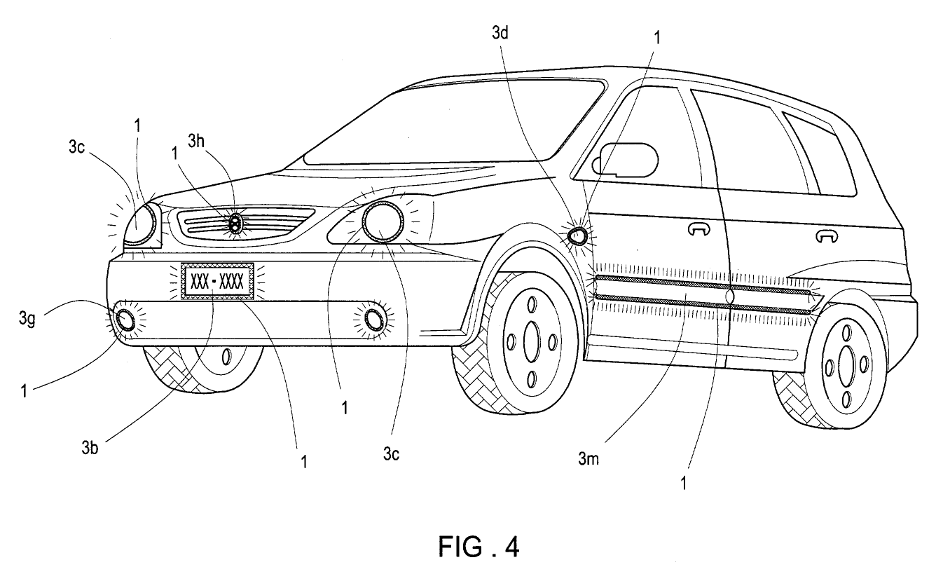

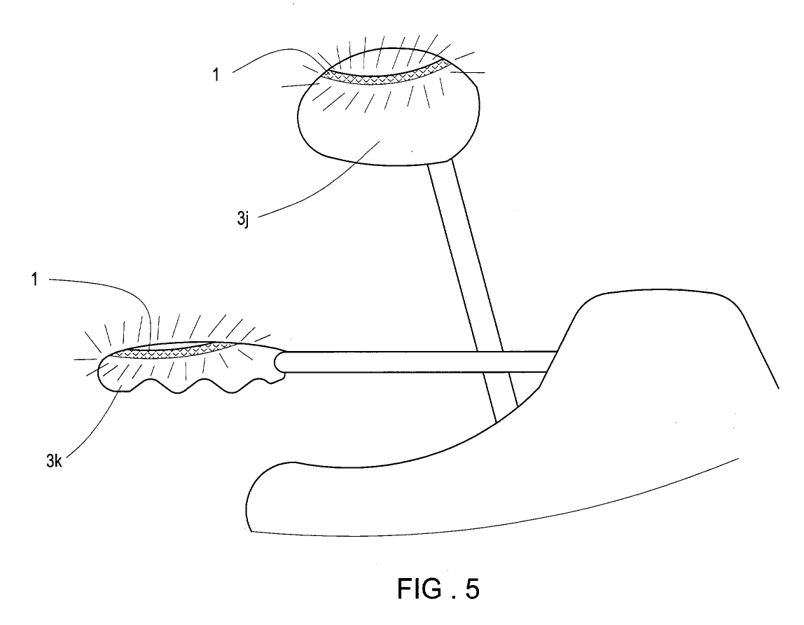

Refer to FIG. 4 & FIG. 5, due to the light-emitting diode 2 disposed inside the groove 11 of the light guiding loop 1, the light is radiated from the light-emitting diode 2 through the light guiding loop 1 to light above parts for safety warning. Thus even light from the surroundings is faded, cars from opposite or rear side can be warned by the shining light guiding loops 1 so as to have better warning effect.

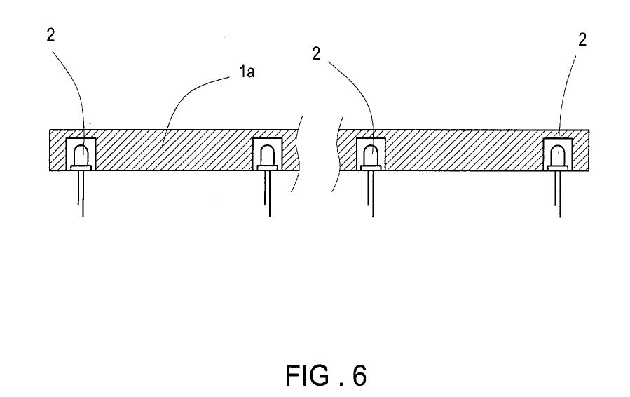

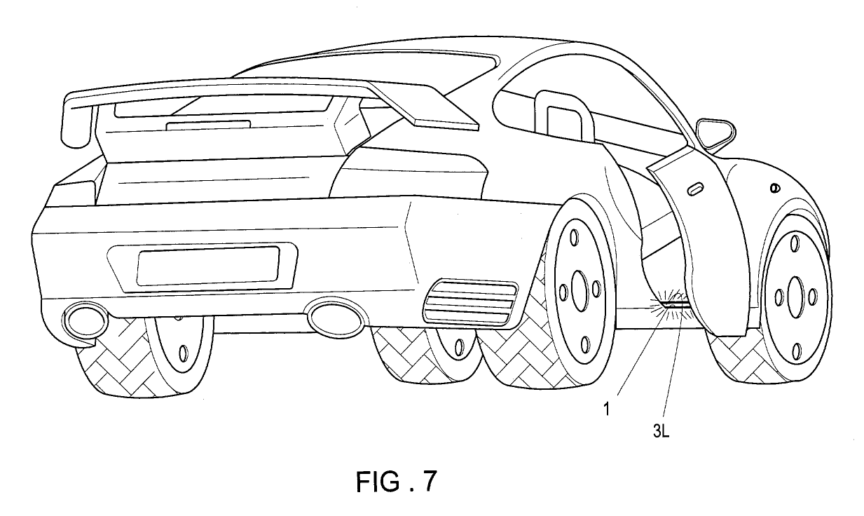

Refer to FIG. 7, the light guiding loop 1 can be designed to a linear light guiding bar 1a for being arranged on the car doorsills as safety illuminator. Refer to FIG. 6, the light from the linear light guiding bar 1a can direct and show people the right way while getting on or off cars so as to avoid stumble. This is another embodiment of the present invention.

Moreover, the light guiding bar 1a can be used as decorative edgings 3m, as shown in FIG. 4, so as to highlight the style of the vehicle for reminding cars from opposite or rear side. This is a further embodiment of the present invention.

It should be noted that the above description and accompanying drawings are only used to illustrate some embodiments of the present invention, not intended to limit the scope thereof. Any modification of the embodiments should fall within the scope of the present invention.

1. An auxiliary Illuminator for Vehicles comprising a light guiding loop with a plurality of grooves thereof;
and a plurality of light-emitting diode disposed on each of said light guiding loop; thus said light guiding loop emits homogeneous light inward.

2. The auxiliary Illuminator for Vehicles as claimed in claim 1, wherein said light guiding loop is disposed on rear view mirrors, frames for license plates, headlights, turn signals, tail lights, fog lights, and trademarks of manufactures.

3. The auxiliary Illuminator for Vehicles as claimed in claim 1, wherein said light guiding loop is designed into a linear shape for being disposed on doorsills or edgings of vehicles as safety lighting.
